(19) United States
(12) Patent Application Publication
(10) Pub. No.: US 2003/0036957 A1
(43) Pub. Date: Feb. 20, 2003

(54) Internet related discount coupon rebate business method

(76) Inventor: Martin Khang Nguyen, Westminster, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 10/211,386

(22) Filed: Aug. 2, 2002

Related U.S. Application Data
(63) Continuation-in-part of application No. 09/931,677, filed on Aug. 15, 2001.

(51) Int. Cl. G06F 17/60

(52) U.S. Cl. 705/14

(57) ABSTRACT

A method of avoiding the use of discount coupons comprises the steps of advertising a plurality of products available for purchase from a plurality of vendors at a discount according to related discount coupons, and purchasing a plurality of the advertised products by a plurality of consumers, from the vendors without using the related discount coupons, and transmitting discount coupon data of the discount coupons related to the purchased products, and proof of purchase data, over the Internet to a discount payment clearinghouse, and transmitting purchase confirmation data, by the vendors, to the discount payment clearinghouse; and transmitting requests for payment of the discounts, by the consumers, to the discount payment clearinghouse. The clearinghouse then correlates the coupon data, proof of purchase data and purchase confirmation data and pays out cash discounts to the consumers in accordance with the correlated data.

### RELATED PATENT APPLICATIONS

The present application claims priority, as a continuation in part, of a prior filed application that is copending, with Ser. No., 09/931,677 and official filing date of, Aug. 15, 2001.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to consumer discount purchase methods and more particularly to a business method for obtaining consumer discounts without presenting discount coupons.

2. Description of Related Art

The following art defines the present state of this field:

Valencia et al., U.S. Pat. No. 5,380,991 describes a system and method of allowing a shopper to obtain the benefit of reduced prices for certain items without the necessity of redeeming paper coupons. The system employs an integrated circuit (IC) smart card containing an erasable memory therein. This memory would contain information relating to a discount coupon amount, as well as information relating to particular products which have been purchased. This card would be inserted into a reader/writer terminal provided at a retailer's checkout counter. Items which are purchased are scanned and compared with items to be discounted as well as the information provided by the customer IC smart card. After the cashier has totaled the customer's purchases, the information contained in the IC smart card would be altered accordingly.

Powell, U.S. Pat. No. 5,727,153 describes a system for creating, dispensing, and redeeming electronic discount coupons in a store. The system includes a “smart card”, product stations adjacent to selected products in the store, and a checkout station in the checkout area. To create an electronic coupon, the customer inserts the card into the product station adjacent to an product the customer wishes to purchase, and the product station then writes an electronic coupon onto the card. The customer thus shops throughout the store collecting electronic coupons for products of interest. Upon completion of shopping, the customer redeems the electronic coupons at the checkout area, by inserting the card into the checkout station. During checkout, when UPC data matches data stored on the card, the customer is credited with the value of the corresponding coupon. Periodically, the electronic coupon data is transferred to a remote clearing house.

Stich, et al., U.S. Pat. No. 5,760,381 describes debit cards, such as long distance telephone cards, being attractively packaged and even readily mounted for point of purchase display, in such a manner that the card is inactive until activated at the point of purchase. The card may be activated at the point of purchase without the necessity of in any way opening up the attractive packaging, or moving any portion of the packaging out of the way, and by merely “swiping” the card while still mounted in the package through a conventional card reader. The card is mounted between first and second panels of primarily cellulose material including an area significantly greater than that of the card, with the card magnetic strip completely exposed (that is uncovered by the panels or any other packaging material). The majority of the card is typically sandwiched between the first and second panels and is removably held to the panels, for example by hold melt adhesive, and the panels are affixed to each other.

Baron et al., U.S. Pat. No. 5,809,481 describes a method and system for advertising that provides advertisers with a marketing database listing contact information for all potential consumers who received a promotional item from that advertiser and decided to retain the promotional item for future use. The promotional item is a tag bearing an advertisement, a contact identifier and a unique tag identifier. After receiving the tag from an advertiser, each recipient is instructed to attach the tag to a personal property item and to register the item with a processing facility that, with the use of an information storage and retrieval system, will create a master database comprising each recipient's contact information and tag identifier. The master database can be used to arrange for the return of a lost personal property item bearing a registered tag. The master database can also be sorted and contact information can be extracted therefrom to generate a marketing database for transmittal to advertisers.

Fajkowski, U.S. Pat. No. 5,905,246 describes a system for the electronic management and redemption of coupons. The system includes an integrated coupon card comprising a microprocessor, a random access memory, a scanner, and a communications port. The coupon card is capable of scanning coupon bar codes from paper coupons and receiving redemption requirement data from a periphery device. The coupon card will allow bar codes and redemption requirement data to be transferred to a periphery device and will store what bar codes were redeemed because they corresponded to purchase data received from a cash register memory. The system further includes one or more periphery devices having a microprocessor, a first communications port for communicating with said coupon card, and a second communications port for communicating with a cash register. The periphery devices receive purchase data from a cash register memory and compare purchase data to coupon bar codes received from a coupon card in order to determine which coupons are redeemable. The system also includes a server computer which will be connected to the periphery devices. The server computer will collect redeemed coupon information from the periphery devices and also provide the periphery devices with information such redemption requirement data or coupons which may be loaded onto a coupon card. A clearing house will collect coupon redemption information from all servers in the system to create redemption reports. The clearing house allows redemption requirement data and other information to be transferred through the servers to individual periphery devices and/or coupon cards.

Fiala, et al., U.S. Pat. No. 5,918,909 describes a method of activating a metered account that is associated with a personal identification number, where the personal identification number is affixed to a card and the metered account is activated at the time of sale of the card, and an apparatus comprising a package adapted for holding the card so that the method of the present invention can be practiced. The card includes an exposed data-encoded strip and the card preferably has a personal identification number thereon. The package includes a first panel and a retainer that secures the card to the first panel so that, when the card is secured to the panel, at least a portion of the data-encoded strip is exposed and laterally displaced remote from the panel. The data-encoded strip is encoded with a control number that is associated with the metered account. When the card is purchased, the control number is read from the data-encoded strip while the card is secured to the first panel, and the metered account is activated.

Christensen, U.S. Pat. No. 6,035,280 describes a method and apparatus for distributing, generating, and redeeming discount Virtual Coupons.™, rebate or gift certificates or the like which may be used on conjunction with a frequency card program or the like. Virtual Coupons.™ may be distributed electronically, for example, in the form of a diskette or CD-ROM software. Software on the diskette or CD-ROM may prompt a consumer to call a 1-800 number for a validation number or code. During the phone call, telemarketing personnel may request consumer demographic and or identification information which may be entered into a centralized database. Once the software is validated, a consumer may print out a list selected Virtual Coupons.™ displayed on a Graphical User Interface (GUI). When a product is purchased, the UPC code of the product may be compared electronically with a list of Virtual Coupons.™ authorized for a particular consumer. An appropriate coupon discount may then be applied and the Virtual Coupon.™ may be considered “redeemed”.

Once redeemed, consumer ID information and Virtual Coupon.™ information may be retrieved electronically and used to update a central database. Accurate data may then be produced illustrating which consumers or groups of consumers are redeeming which Virtual Coupons.™. Such data may be used for marketing purposes or to generated further diskettes for distribution targeting specific consumers or groups of consumers with specific classes of Virtual Coupon.™ offerings. The use of Virtual Coupons.™ eliminates or reduces fraud, and allows a frequency card discount to be applied only a limited number of times.

Fertig, U.S. Pat. No. 6,050,493 describes a pre-paid card for sending a gift such as flowers that is sized to fit inside a wallet, having a front face with photographs or drawings with a plurality of pre-selected gift items and back face with warranty and instructional information, as well as a telephone access number and a PIN number which is unique to the card. A plurality of pre-selected items depicted on the front face of the card will each have a corresponding identifier number or code, so that the card user can easily select a gift item to be ordered.

Bowie, U.S. Pat. No. 6,195,644 describes a method whereby credit card companies can program their computers to record and award Bonus Program Credits offered by airlines, hotels, rental car companies, etc. and relieve the latter of the burden of maintaining such records. This Abstract is not to be construed as a complete description of the invention or to limit the scope of the disclosure of the invention or of the claims.

Powell, U.S. Pat. No. 6,243,687 describes a system for dispensing and redeeming electronic discount coupons in a store. A card-dispensing kiosk collects information from a customer and subsequently issues a “smart card” for storing electronic coupons. Upon completion of shopping, the customer redeems the electronic coupons at the checkout area, by inserting the card into the checkout station. During checkout, when UPC product data corresponds to coupons stored on the card, the customer is credited with the value of the corresponding coupon.

The prior art teaches the use of coupons, paperless coupons, electronic coupons and such, but does not teach a method of use of coupons which need not be presented at the point of purchase. The present invention fulfills these needs and provides further related advantages as described in the following summary.

### SUMMARY OF THE INVENTION

The present invention teaches certain benefits in construction and use which give rise to the objectives described below.

A method of avoiding the use of discount coupons, such as paper coupons, comprises the steps of advertising a plurality of products available for purchase from a plurality of vendors at a discount according to related discount coupons, and purchasing a plurality of the advertised products by a plurality of consumers, from the vendors without using the related discount coupons, and transmitting discount coupon data of the discount coupons related to the purchased products, and proof of purchase data, over the Internet to a discount payment clearinghouse, and transmitting purchase confirmation data, by the vendors, to the discount payment clearinghouse; and transmitting requests for payment of the discounts, by the consumers, to the discount payment clearinghouse. The clearinghouse then correlates the coupon data, proof of purchase data and purchase confirmation data and pays out cash discounts to the consumers in accordance with the correlated data.

A primary objective of the present invention is to provide an apparatus and method of use of such apparatus that provides advantages not taught by the prior art.

Another objective is to provide such an invention capable of enabling consumer purchase discounts without using paper discount coupons.

A further objective is to provide such an invention capable of transmitting data using the Internet.

A still further objective is to provide such an invention capable of providing instant discount applications without presenting discount coupons.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawing illustrate the present invention. In such drawing:

FIG. 1 is a diagram illustrating the relationship between consumers, vendors and a discount clearinghouse of the invention method.

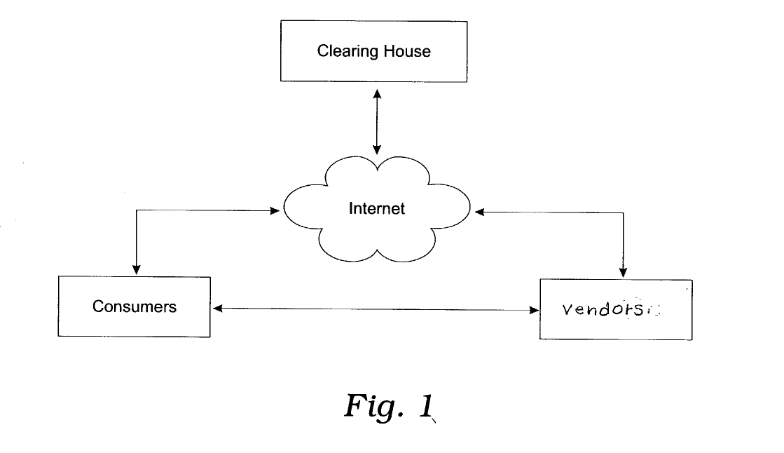

### DETAILED DESCRIPTION OF THE INVENTION

The above described drawing figures illustrate the invention in at least one of its preferred embodiments, which is further defined in detail in the following description.

The present invention is a method of avoiding the use of discount coupons of any type but especially the paper coupons of the type that are commonly posted to newspapers, retail store publications, and found in mailed coupon sets and the like, or available on the Internet. The method includes the step of first advertising a plurality of products available for purchase from a plurality of vendors at a discount price, and this is communicated according to related paper discount coupons and the like. Such discount coupons may also be provided in coupon packs which are commonly mailed to consumers. The consumers act on these discounts and purchase a plurality of the advertised products from the vendors. Typically this kind of purchase is completed by presenting the paper coupon at the time of purchase. However, in the present method the purchase is made without using the related paper discount coupons. In a first embodiment of the present invention, the consumers make the purchase at a non-discounted price and later transmit discount coupon data found on the discount coupons related to the purchased products, over the Internet to a discount payment clearinghouse which is setup specifically to handle such transactions. The consumer also transmits a proof of purchase data concerning the purchased products, over the Internet to the clearinghouse. The proof of purchase is typically a sales receipt and the discount data is found on the paper discount coupon which has been retained by the consumer. Purchase confirmation data, is transmitted by the vendors to the clearinghouse to assure the clearinghouse that counterfeit proof of purchase data cannot be used. The consumer next transmits a request for payment of the discounts, to the clearinghouse. After correlating the coupon data, proof of purchase data and purchase confirmation data payment is made by the clearinghouse to the consumer in accordance with the correlated data. Such a clearinghouse provides a service to the consumer and the vendor and could be setup to receive revenue from both in the form of a membership fee.

Preferably, the step of entering the discount coupon data and the proof of purchase data, by the consumers, into their personal computers is useful when these computers are enabled for data interchange with the Internet as is well known in the art. Such data entry is preferably completed using an optical scanning device such as is well known using bar-code or the like.

In an alternate embodiment of the present invention method, the proof of purchase data, purchase confirmation data and discount coupon data are entered into consumer data storage cards, or similar other memory devices, during the purchasing step. Such cards are well known in the art and generally contain a storage device such as a microchip. Equipment for entering and reading data with such cards is well known. During the purchase of discounted merchandise, such data is entered into the consumers card. This if followed by the step of downloading the proof of purchase data, purchase confirmation data and discount coupon data from the data storage card to the consumer's computer and then forwarding the data to the clearinghouse via the Internet.

In a further alternate embodiment of the present invention method, the available purchase discounts data is posted to the Internet by the clearinghouse. The consumer then may inquire as to available purchase discounts using the consumer's computer for data interchange through the Internet. The consumer may then download the available purchase discounts data to the consumer data storage card using the consumer's computers for data interchange through the Internet and may then receive discounts related to the discounts data at the time of the purchase by presenting the consumers data storage card to the vendor.

Clearly, the present invention is directed at the avoidance of clipping, sorting, carrying and using paper discount coupons, but it is not limited thereto, but rather to the avoidance of using any of a wide assortment of common, prior art, discount device, paper or paperless.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A method of avoiding the use of discount coupons comprising the steps of: advertising a plurality of products available for purchase from a plurality of vendors at a discount according to related discount coupons; purchasing a plurality of the advertised products by a plurality of consumers, from the vendors without using the related discount coupons; transmitting discount coupon data of the discount coupons related to the purchased products, by the consumers, over the Internet to a discount payment clearinghouse; transmitting proof of purchase data of the purchased products, by the consumers, over the Internet to the discount payment clearinghouse; transmitting purchase confirmation data, by the vendors, to the discount payment clearinghouse; transmitting requests for payment of the discounts, by the consumers, to the discount payment clearinghouse; correlating the coupon data, proof of purchase data and purchase confirmation data by the discount payment clearinghouse; and paying discounts to the consumers in accordance with the correlated data.

2. The method of claim 1 further comprising the step of entering the discount coupon data and the proof of purchase data, by the consumers, into personal computers of the consumers, the personal computers enabled for data interchange with the Internet.

3. The method of claim 2 wherein the step of data entry is completed using one of an optical and a magnetic scanning device.

4. The method of claim 2 further comprising the step of entering the proof of purchase data, purchase confirmation data and discount coupon data into a consumer data storage device during the purchasing step.

5. The method of claim 4 wherein the step of data entry is completed by downloading the proof of purchase data, purchase confirmation data and discount coupon data from the data storage device to the consumer computers.

6. The method of claim 1 further comprising the steps of posting available purchase discounts data, by the discount payment clearinghouse, to the Internet; and inquiring of the available purchase discounts by the consumers using the computers for data interchange through the Internet.

7. The method of claim 6 further comprising the steps of downloading the available purchase discounts data to consumer data storage cards using the computers for data interchange through the Internet; and receiving discounts related to the discounts data at the time of the purchases.

8. The method of claim 7 wherein the discounts are paid to the consumers by one of cash, check, direct deposit into bank accounts of the consumers and provision for future discount privileges in consumer purchases.
